(19) United States
(12) Patent Application Publication
(10) Pub. No.: US 2016/0313611 A1
(43) Pub. Date: Oct. 27, 2016

(54) LIQUID CRYSTAL PANEL AND DISPLAY APPARATUS

(71) Applicant: Shenzhen China Star Optoelectronics Technology Co., Ltd., Shenzhen, Guangdong (CN)

(72) Inventor: Xiangyang XU, Shenzhen, Guangdong (CN)

(73) Assignee: Shenzhen China Star Optoelectronics Technology Co., Ltd., Shenzhen, Guangdong (CN)

(21) Appl. No.: 14/765,652

(22) PCT Filed: May 14, 2015
(86) PCT No.: PCT/CN2015/078915

§ 371 Date: Aug. 4, 2015

(30) Foreign Application Priority Data
Apr. 27, 2015 (CN) 201510204488.4

(51) Int. Cl. G02F 1/1343; G02F 1/1335

(52) U.S. Cl. CPC G02F 1/134309; G02F 1/133514; G02F 2201/123; G02F 2201/121; G02F 2001/134318; G02F 2001/133342

(57) ABSTRACT

The disclosure is related to a liquid crystal panel. The liquid crystal panel comprises a color filter substrate, an array substrate and a liquid crystal layer disposed between the color filter substrate and the array substrate. A common electrode layer is disposed at the side of the color filter substrate toward the liquid crystal layer. A pixel electrode layer is disposed at the side of the array substrate toward the liquid crystal layer. The common electrode layer and the pixel electrode layer are disposed symmetrically. The common electrode layer comprises a first common electrode region and a second common electrode region. The pixel electrode layer comprises a first pixel electrode region and a second pixel electrode region. Four domain regions are arranged in the first common electrode region and the first pixel electrode region. The disclosure further provides a display apparatus.

This application claims the benefit of, and priority to, Chinese Patent Application No. 201510204488.4, filed Apr. 27, 2015, titled “Liquid Crystal Panel and Display Apparatus”, the entire contents of which are incorporated by reference herein in its entirety.

### BACKGROUND

1. Technical Field

The disclosure is related to the field of liquid crystal display technology, and more particularly to a liquid crystal panel and a display apparatus.

2. Related Art

The liquid crystal display device as a display part of the electronic apparatus has been widely used in various electronic products at present. The display panel of the liquid crystal display device as well as visual angle, brightness and color, are related to the display effects of the liquid crystal display apparatus. Thin film transistors as switch devices are generally applied in liquid crystal display devices and other electronic devices. The present liquid crystal panel comprises a TFT array substrate and a color filter substrate disposed opposite to each other as well as a liquid crystal layer sandwiched between the array substrate and the color filter substrate. The plastic frame is formed between the color filter substrate and the array substrate to seal the liquid crystal.

A technique called Polymer Stabilized Vertical Alignment (PSVA) is developed by the industry. This technique is practiced by mixing the monomer compound in suitable concentration with the liquid crystal material and well shaking. Then, the mixed liquid crystal material is heated by the heater to achieve the Isotropy status. The liquid crystal mixture returns to the nematic status when the liquid crystal mixture cools down to the room temperature. After that, the liquid crystal mixture is injected into the liquid crystal cell and applied with the voltage. After the liquid crystal molecules are arranged stably by the applied voltage, the ultraviolet light or heating method is used to make the monomer compound polymerized to generate the polymer layer. Thereby, the purpose of the stable alignment of is achieved.

Generally speaking, the design with eight domain structures is usually adopted in the liquid crystal panel with PSVA in order to increase the visual angle. That is, the pixel electrode corresponding to each subpixel region is divided into a large region and a small region. The four-domain structure is disposed at the two electrode regions. Each electrode region is driven by a TFT. However, the asymmetric type of the electrode segmentation easily restful in occurrence of the color shifting. A TFT sharing switch is added in order to overcome the color shifting. However, the partial light is obscured by the added TFT sharing switch, and thereby, the aperture ratio of the display panel is affected.

### SUMMARY

The embodiment of the disclosure provides a liquid crystal panel, so as to increase the aperture ratio of the liquid crystal display panel without having influence on the visual angle.

The embodiment of the disclosure further provides a display apparatus.

The embodiment of the disclosure provides a liquid crystal panel. The liquid crystal panel comprises a color filter substrate, an array substrate and a liquid crystal layer disposed between the color filter substrate and the array substrate. A common electrode layer is disposed at the side of the color filter substrate toward the liquid crystal layer. A pixel electrode layer is disposed at the side of the array substrate toward the liquid crystal layer. The common electrode layer and the pixel electrode layer are disposed symmetrically. The common electrode layer comprises a first common electrode region and a second common electrode region. The first common electrode region and the second common electrode region are separated through a gap and symmetrically disposed with the center line of the gap. The pixel electrode layer comprises a first pixel electrode region and a second pixel electrode region. The first pixel electrode region and the second pixel electrode region are separated through a gap and symmetrically disposed with the center line of the gap. Four domain regions are arranged in the first common electrode region. The first common electrode region and the second pixel electrode region are disposed opposite to each other. Four domain regions are arranged in the first pixel electrode region. The first pixel electrode region and the second common electrode region are disposed opposite to each other.

In some alternative embodiments, the first common electrode region and the second pixel electrode region are symmetrically disposed at the two sides of the liquid crystal layer; the second common electrode region and the first pixel electrode region are symmetrically disposed at the two sides of the liquid crystal layer.

In some alternative embodiments, a first groove in a cross shape is disposed in the first common electrode region; the first common electrode region is separated into the four domain regions by the first groove.

In some alternative embodiments, a second groove in a cross shape is disposed in the first pixel electrode region; the first pixel electrode region is separated into the four domain regions by the second groove.

In some alternative embodiments, a plurality of regularly arranged cracks are disposed in the four domain regions of the first common electrode region, and are arranged in parallel along the two sides of the first groove by way of an angle with the first groove, and thereby the four domain regions of the first common electrode region forms a “ [symbol] ” pattern; a plurality of regularly arranged cracks are disposed in the four domain regions of the first pixel electrode region, and are arranged in parallel along the two sides of the second groove by way of an angle with the second groove.

In some alternative embodiments, the array substrate further comprises a first metal electrode electrically connecting to the first pixel electrode region.

In some alternative embodiments, the array substrate further comprises a second metal electrode electrically connecting to the second pixel electrode region.

The embodiment of the disclosure further provides a display apparatus. The display apparatus comprises a liquid crystal panel, wherein the liquid crystal panel is a double-sided display panel. The liquid crystal panel comprises a color filter substrate, an array substrate and a liquid crystal layer disposed between the color filter substrate and the array substrate. A common electrode layer is disposed at the side of the color filter substrate toward the liquid crystal layer. A pixel electrode layer is disposed at the side of the array substrate toward the liquid crystal layer. The common electrode layer and the pixel electrode layer are disposed symmetrically. The common electrode layer comprises a first common electrode region and a second common electrode region. The first common electrode region and the second common electrode region are separated through a gap and symmetrically disposed with the center line of the gap. The pixel electrode layer comprises a first pixel electrode region and a second pixel electrode region. The first pixel electrode region and the second pixel electrode region are separated through a gap and symmetrically disposed with the center line of the gap. Four domain regions are arranged in the first common electrode region. The first common electrode region and the second pixel electrode region are disposed opposite to each other. Four domain regions are arranged in the first pixel electrode region. The first pixel electrode region and the second common electrode region are disposed opposite to each other.

In some alternative embodiments, the first common electrode region and the second pixel electrode region are symmetrically disposed at the two sides of the liquid crystal layer; the second common electrode region and the first pixel electrode region are symmetrically disposed at the two side of the liquid crystal layer.

In some alternative embodiments, the array substrate further comprises a first metal electrode electrically connecting to the first pixel electrode region.

The first pixel electrode region and the second pixel electrode region are symmetrically disposed. Four domain regions are arranged in the first pixel electrode region. The first common electrode region and the second common electrode region are disposed opposite to each other. Four domain regions are arranged in the first common electrode region. The degree of visual angels generated by the uniform distribution method are the same no matter it adopts the side of the array substrate or the side of the color filter substrate for lighting emission. The color shifting is not generated by the uneven distribution of pixel electrodes. The first common electrode region of the liquid crystal panel is charged by the color filter. The first pixel electrode region is charged by the array substrate. Without affecting the charging efficiency, one switch of the pixel electrodes is reduced as compared with the current technique and the aperture ratio of the panel is increased.

### BRIEF DESCRIPTION OF THE DRAWINGS

In order to more clearly illustrate the prior art or the embodiments or aspects of the practice of the disclosure, the accompanying drawings for illustrating the prior art or the embodiments of the disclosure are briefly described as below. It is apparently that the drawings described below are merely some embodiments of the disclosure, and those skilled in the art may derive other drawings according the drawings described below without creative endeavor.

FIG. 1 is a cross-section view of the liquid crystal display panel according to the embodiment of the disclosure;

FIG. 2 is a schematic of the array substrate of the liquid crystal panel as shown in FIG. 1; and

FIG. 3 is a schematic of the color filter substrate of the liquid crystal panel as shown in FIG. 1.

### DETAILED DESCRIPTION

The following description with reference to the accompanying drawings is provided to clearly and completely explain the exemplary embodiments of the disclosure. It is apparent that the following embodiments are merely some embodiments of the disclosure rather than all embodiments of the disclosure. According to the embodiments in the disclosure, all the other embodiments attainable by those skilled in the art without creative endeavor belong to the protection scope of the disclosure.

The embodiment of the disclosure provides a display apparatus and a liquid crystal panel. The liquid crystal panel is a dual display panel and provides for displaying at dual side.

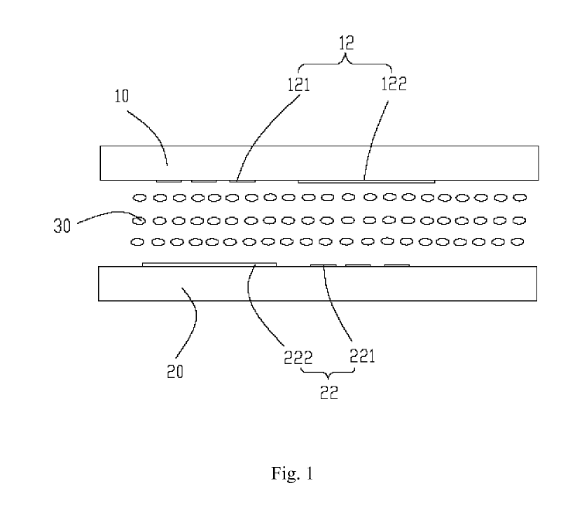

Refer to FIG. 1. The liquid crystal panel comprises a color filter substrate 10, an array substrate 20 and a liquid crystal layer 30 disposed between the color filter substrate 10 and the array substrate 20. A common electrode layer 12 is disposed at the side of the color filter substrate 10 toward the liquid crystal layer 30. A pixel electrode layer 22 is disposed at the side of the array substrate 20 toward the liquid crystal layer 30. The common electrode layer 12 and the pixel electrode layer 22 are disposed symmetrically. The common electrode layer 12 comprises a first common electrode region 121 and a second common electrode region 122. The first common electrode region 121 and the second common electrode region 122 are separated through a gap and symmetrically disposed with the center line of the gap. The pixel electrode layer 22 comprises a first pixel electrode region 221 and a second pixel electrode region 222. The first pixel electrode region 221 and the second pixel electrode region 222 are separated through a gap and symmetrically disposed with the center line of the gap. Four domain regions are arranged in the first common electrode region 121. The first common electrode region 121 and the second pixel electrode region 222 are disposed opposite to each other. Four domain regions are arranged in the first pixel electrode region 221. The first pixel electrode region 221 and the second common electrode region 122 are disposed opposite to each other.

In the embodiment of the disclosure, the liquid crystal panel further comprises a plurality of pixel unit. Each pixel unit comprises a plurality of independent subpixel. Each subpixel is corresponding to a pixel electrode. In the embodiment, a subpixel is described as an example. The person skilled in the art understands that the subpixel in the embodiment described below with respect to other subpixel structures in the plurality of subpixels. The pixel electrode layer 22 is disposed corresponding to the subpixel. In the embodiment, the pixel electrode layer 22 is separated into two regions, which are a first pixel electrode region 221 and a second pixel electrode region 222. The subpixel corresponding to the first pixel electrode region 221 is formed as a first subpixel. The subpixel corresponding to the second pixel electrode region 222 is formed as a second subpixel (not shown). The first pixel electrode region 221 and the first common electrode region 121 are disposed at two light exiting surfaces. In the embodiment, the first pixel electrode region 221 and the second pixel electrode region 222 are separated through a gap and symmetrically disposed with the center line of the gap. The first common electrode region 121 and the second common electrode region 122 are symmetrically formed on the common electrode layer 12 and correspond to the first subpixel and the second subpixel.

The liquid crystal layer between the first common electrode region 121 and the second pixel electrode region 222 arranged appropriately is driven by the electric driving field. The electric driving field is formed by the voltage generated between the first common electrode region 121 and the second pixel electrode region 222 of the liquid crystal panel. The liquid crystal layer between the first pixel electrode region 221 and the second common electrode region 122 arranged appropriately is driven by the electric driving field. The electric driving field is formed by the voltage generated between the first pixel electrode region 221 and the second common electrode region 122. The first pixel electrode region 221 and the second pixel electrode region 222 are symmetrically disposed and the size of each region is exactly equal. Four domain regions are arranged in the first pixel electrode region 221. The first common electrode region 121 and the second common electrode region 122 are symmetrically disposed and the size of each region is exactly equal. Four domain regions are arranged in the first common electrode region 121. The degree of visual angels generated by the uniform distribution method are the same no matter it adopts the side of the array substrate 20 or the side of the color filter substrate 10 for light emission. The color shifting is not generated by the uneven distribution of pixel electrodes. The first common electrode region 121 of the liquid crystal panel is charged by the color filter 10. The second pixel electrode region 222 is charged by the array substrate 20. The first pixel electrode region 221 is charged by the array substrate 20. The second common electrode region 122 of the liquid crystal panel is charged by the color filter 10. Without affecting the charging efficiency, one switch of the pixel electrodes is reduced as compared with the current technique and the aperture ratio of the panel is increased.

Further, the first common electrode region 121 and the second pixel electrode region 222 are symmetrically disposed at the two sides of the liquid crystal layer 30. The second common electrode region 122 and the first pixel electrode region 221 are symmetrically disposed at the two sides of the liquid crystal layer 30. In the embodiment, the shape and the size of each directions of the second common electrode region 122 and the first pixel electrode region 221 are exactly equal. In other embodiments, the size of the first common electrode region 121 and the second pixel electrode region 222 could be different. The first common electrode region 121 is in the covered region of the second pixel electrode region 222. The size of the second common electrode region 122 and the first pixel electrode region 221 could be different. The second common electrode region 122 is in the covered region of the first pixel electrode region 221.

Further, the cracks disposed in the four domain regions of the first common electrode region 121 and the four domain regions of the first pixel electrode region 221 are regularly arranged. The snowflake-like pattern is formed by the four domain regions of the first common electrode region 121. The snowflake-like pattern is formed by the four domain regions of the first pixel electrode region 221.

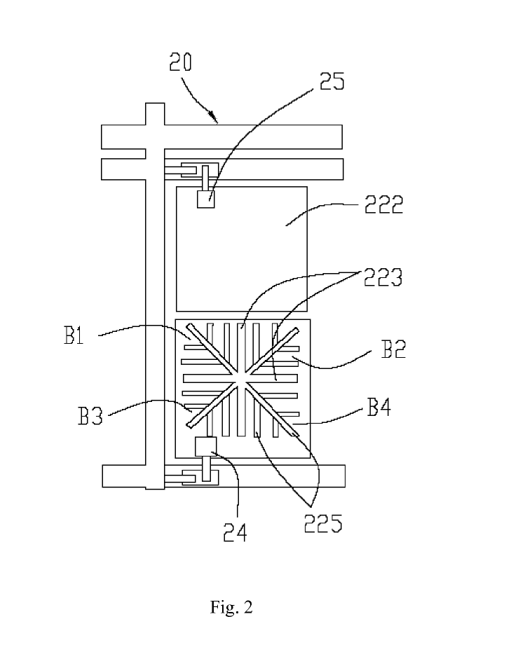

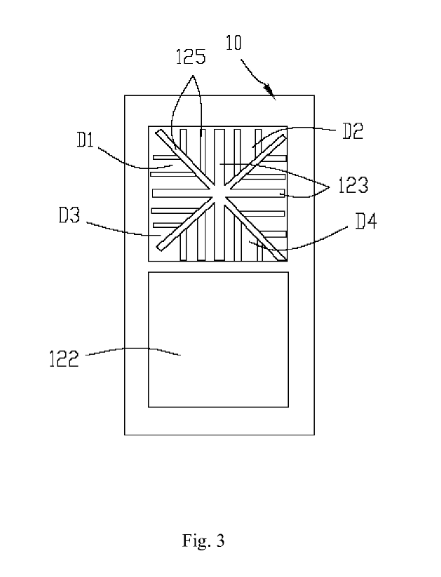

Refer to FIG. 2 and FIG. 3. A first groove 123 in a cross shape is disposed in the first common electrode region 121. The first common electrode region 121 is separated into the four domain regions by the first groove 123. In the embodiment, the four domain regions comprises an upper left region D1, an upper right region D2, a lower left region D3 and lower right region D4. Cracks 125 are regularly arranged in the regions D1, D2, D3 and D4. In the embodiment, D1 as an example, the terminal of the cracks 125 started from the first groove 123 and arranged in parallel along the two sides of the first groove 123 by way of an angle with the first groove 123. The cracks 125 in the regions D1, D2, D3 and D4 form a snowflake-like pattern or a “ [symbol] ” pattern. The cracks 125 in the regions D1, D2, D3 and D4 in the embodiment of the disclosure form a “ [symbol] ” pattern.

Further, a second groove 223 in a cross shape is disposed in the first pixel electrode region 221. The first pixel electrode region 221 is separated into the four domain regions by the second groove 223. In the embodiment, the four domain regions comprises an upper left region B1, an upper right region B2, a lower left region B3 and lower right region B4. Cracks 225 are regularly arranged in the regions B1, B2, B3 and B4. In the embodiment, B1 as an example, the terminal of the cracks 225 started from the second grooves 223 and arranged in parallel along the two sides of the second groove 223 by way of an angle with the second groove 223. The cracks 225 in the regions D1, D2, D3 and D4 form a snowflake-like pattern or a “ [symbol] ” pattern. The cracks 225 in the regions D1, D2, D3 and D4 in the embodiment of the disclosure form a “ [symbol] ” pattern.

Further, the array substrate 20 further comprises a first metal electrode 24 electrically connecting to the first pixel electrode 221. The first metal electrode 24 provides an electric power to the first pixel electrode 221. The array substrate 20 further comprises a second metal electrode 25 electrically connecting to the second pixel electrode 222. The first pixel electrode 221 of the embodiment of the disclosure is only needed one first metal electrode 24 to provide the electric power.

The first pixel electrode region and the second pixel electrode region are symmetrically disposed. Four domain regions are arranged in the first pixel electrode region. The first common electrode region and the second common electrode region are disposed opposite to each other. Four domain regions are arranged in the first common electrode region. The degree of visual angels generated by the uniform distribution method are the same no matter it adopts the side of the array substrate or the side of the color filter substrate. The color shifting is not generated by the uneven distribution of pixel electrodes. The first common electrode region of the liquid crystal panel is charged by the color filter. The first pixel electrode region is charged by the array substrate. Without affecting the charging efficiency, one switch of the pixel electrodes is reduced as compared with the current technique and the aperture ratio of the panel is increased.

Note that the specifications relating to the above embodiments should be construed as exemplary rather than as limitative of the present disclosure. The equivalent variations and modifications on the structures or the process by reference to the specification and the drawings of the disclosure, or application to the other relevant technology fields directly or indirectly should be construed similarly as falling within the protection scope of the disclosure.

What is claimed is:

1. A liquid crystal panel, comprising:
a color filter substrate;
an array substrate;
a liquid crystal layer disposed between the color filter substrate and the array substrate;
a common electrode layer disposed at the side of the color filter substrate toward the liquid crystal layer; and
a pixel electrode layer disposed at the side of the array substrate toward the liquid crystal layer;
wherein the common electrode layer and the pixel electrode layer are disposed symmetrically;
the common electrode layer comprises a first common electrode region and a second common electrode region; the first common electrode region and the second common electrode region are separated through a gap and symmetrically disposed with the center line of the gap;
the pixel electrode layer comprises a first pixel electrode region and a second pixel electrode region; the first pixel electrode region and the second pixel electrode region are separated through a gap and symmetrically disposed with the center line of the gap;
four domain regions are arranged in the first common electrode region and the first pixel electrode region respectively; the first common electrode region and the second pixel electrode region are disposed opposite to each other; the first pixel electrode region and the second common electrode region are disposed opposite to each other.

2. The liquid crystal panel according to claim 1, wherein the first common electrode region and the second pixel electrode region are symmetrically disposed at the two sides of the liquid crystal layer; the second common electrode region and the first pixel electrode region are symmetrically disposed at the two sides of the liquid crystal layer.

3. The liquid crystal panel according to claim 1, wherein a first groove in a cross shape is disposed in the first common electrode region; the first common electrode region is separated into the four domain regions by the first groove.

4. The liquid crystal panel according to claim 3, wherein a second groove in a cross shape is disposed in the first pixel electrode region; the first pixel electrode region is separated into the four domain regions by the second groove.

5. The liquid crystal panel according to claim 4, wherein a plurality of regularly arranged cracks are disposed in the four domain regions of the first common electrode region, and are arranged in parallel along the two sides of the first groove by way of an angle with the first groove, and thereby the four domain regions of the first common electrode region forms a “ [symbol] ” pattern; a plurality of regularly arranged cracks are disposed in the four domain regions of the first pixel electrode region, and are arranged in parallel along the two sides of the second groove by way of an angle with the second groove.

6. The liquid crystal panel according to claim 4, wherein the array substrate further comprises a first metal electrode electrically connecting to the first pixel electrode region.

7. The liquid crystal panel according to claim 6, wherein the array substrate further comprises a second metal electrode electrically connecting to the second pixel electrode region.

8. A display apparatus, comprising:
a liquid crystal panel, wherein the liquid crystal panel is a double side display panel; the liquid crystal panel comprises:
a color filter substrate;
an array substrate;
a liquid crystal layer disposed between the color filter substrate and the array substrate;
a common electrode layer disposed at the side of the color filter substrate toward the liquid crystal layer; and
a pixel electrode layer disposed at the side of the array substrate toward the liquid crystal layer;
wherein the common electrode layer and the pixel electrode layer are disposed symmetrically;
the common electrode layer comprises a first common electrode region and a second common electrode region; the first common electrode region and the second common electrode region are separated through a gap and symmetrically disposed with the center line of the gap;
the pixel electrode layer comprises a first pixel electrode region and a second pixel electrode region; the first pixel electrode region and the second pixel electrode region are separated through a gap and symmetrically disposed with the center line of the gap;
four domain regions are arranged in the first common electrode region and the first pixel electrode region respectively; the first common electrode region and the second pixel electrode region are disposed opposite to each other; the first pixel electrode region and the second common electrode region are disposed opposite to each other.

9. The display apparatus according to claim 8, wherein the first common electrode region and the second pixel electrode region are symmetrically disposed at the two sides of the liquid crystal layer; the second common electrode region and the first pixel electrode region are symmetrically disposed at the two sides of the liquid crystal layer.

10. The display apparatus according to claim 9, wherein the array substrate further comprises a first metal electrode electrically connecting to the first pixel electrode region.
